(19) United States
(12) Patent Application Publication
(10) Pub. No.: US 2014/0121305 A1
(43) Pub. Date: May 1, 2014

(54) COMPOSITION CONTAINING ASSOCIATIVE RHEOLOGY MODIFIER AND POLYMER ENCAPSULATED PIGMENT PARTICLES

(71) Applicants: Antony K. van Dyke, (US); Tucker Maxon, (US)

(72) Inventors: Thomas Ward Brown, North Wales, PA (US); Antony K. van Dyk, Blue Bell, PA (US)

(21) Appl. No.: 14/126,907

(22) PCT Filed: Jun. 8, 2012
(86) PCT No.: PCT/US2012/041513

§ 371 Date: Dec. 17, 2013

Related U.S. Application Data
(60) Provisional application No. 61/502,948, filed on Jun. 30, 2011.

(51) Int. Cl. C09D 7/12

(52) U.S. Cl. CPC C09D 7/1225
USPC 524/35; 524/522; 524/507; 524/497

(57) ABSTRACT

The present invention relates to a composition comprising an associative thickener, a binder, polymer encapsulated opacifying pigment particles, and water. The composition of the present invention shows an improvement in opacity and S/mil over similar compositions that do not include polymer encapsulated opacifying pigment particles.

### BACKGROUND OF THE INVENTION

The present invention relates to a composition containing an associative thickener and polymer encapsulated opacifying pigment particles. HEUR associative thickeners are used to thicken architectural and industrial coatings and are well known to impart many desirable properties to coatings such as good leveling, high gloss, and good scrub and water resistance. Nevertheless, associative thickeners in general, and HEUR associative thickeners in particular, can produce reduced opacity compared to non-associative thickeners. It would therefore be an advance in the art to retain all the desirable properties while not sacrificing opacity.

### SUMMARY OF THE INVENTION

The present invention addresses a need in the art by providing a composition comprising:
a) 0.02-10 weight percent of an associative thickener;
b) 1-50 weight percent of a binder;
c) 1-60 weight percent of polymer-encapsulated opacifying pigment particles; and
d) 35-90 weight percent water;
wherein the weight percentages are based on the total weight of the composition;
wherein the opacifying pigment particles have a number average diameter in the range of 100 nm to 500 nm and an index of refraction of at least 1.8; and are encapsulated or partially encapsulated in an encapsulating polymer.

In a second aspect, the present invention is a composition comprising:
a) 0.05-5 weight percent of a HEUR thickener;
b) 1-30 weight percent of a binder;
c) 20-45 weight percent of polymer-encapsulated TiO₂ particles; and
d) 40-70 weight percent water;
wherein the weight percentages are based on the total weight of the composition; and
   wherein the TiO₂ have a number average diameter in the range of 100 nm to 500 nm; and are encapsulated an encapsulating polymer, which polymer-encapsulated TiO₂ particles further include an amphoteric polymeric dispersant for the TiO₂ particles particles and the encapsulating polymer, wherein the amphoteric polymeric dispersant contains amine functionality and sulfur acid functionality.

Coating formulations containing associative thickeners such as HEURs, HASEs, and HMHECs and polymer encapsulated opacifying pigment particles such as TiO₂, show a surprising preservation of opacity as compared to formulations that contain associative thickeners and non-encapsulated opacifying pigment particles.

### DETAILED DESCRIPTION OF THE INVENTION

In a first aspect, the present invention relates to a composition comprising:
a) 0.02-10 weight percent of an associative thickener;
b) 1-50 weight percent of a binder;
c) 1-60 weight percent of polymer-encapsulated opacifying pigment particles; and
d) 35-90 weight percent water;
wherein the weight percentages are based on the total weight of the composition;
wherein the opacifying pigment particles have a number average diameter in the range of 100 nm to 500 nm and an index of refraction of at least 1.8; and are encapsulated or partially encapsulated in an encapsulating polymer.

Examples of associative thickeners include hydrophobically modified ethylene oxide urethane polymers (HEURs); hydrophobically modified alkali soluble or swellable emulsion polymers (HASEs); and hydrophobically modified hydroxyethyl cellulose polymers (HMHECs), and combinations thereof. Commericially available HEURs include ACRYSOL™ RM-2020NPR HEUR Thickening Agent and ACRYSOL™ RM-8W HEUR Thickening Agent (ACRYSOL is a trademark of The Dow Chemical Company or its Affiliates). A commercially available HMHEC is Natrosol Plus 330 hydrophobically modified HEC thickener. A commercially available HASE is ACRYSOL™ RM-7 HASE Thickening Agent.

Another example of a HASE can be prepared in accordance with the following procedure: A first monomer emulsion can be prepared by combining deionized water (684 g), sodium lauryl sulfate (26 g, 28%), (C₁₆₋₁₈) polyethoxy (EO₂₀) methacrylate (26 g), ethyl acrylate (525 g), and methacrylic acid (357 g). A second monomer emulsion can be prepared by combining deionized water (293 g), sodium lauryl sulfate (11 g, 28%), (C₁₆₋₁₈) polyethoxy (EO₂₀) methacrylate (11 g), ethyl acrylate (225 g), methacrylic acid (153 g), and allyl methacrylate (0.19 g). An initiator feed solution can be prepared using ammonium persulfate (0.57 g) in deionized water (120 g); a separate initial initiator solution can be prepared using ammonium persulfate (1.43 g) in deionized water (35 g). Deionized water (1084 g) and sodium lauryl sulfate (37 g, 28%) can be charged to a 5-liter, 4-neck flask equipped with a mechanical stirrer, a reflux condenser topped with a nitrogen inlet, feed inlet ports, and a thermocouple. The reactor contents can be heated to 86° C. and the initial initiator solution can be added. The first monomer emulsion and the initiator feed solution can each be fed separately to the reactor at 21 g/min and 1.09 g/min respectively. Temperature is advantageously maintained at 86° C. throughout feeds. The second monomer emulsion can then be fed to the reactor immediately following the end of the first monomer emulsion addition at the same rate of 21 g/min. Monomer emulsions and initiator feed solution addition can be carried out over 110 min. Upon completion of all feeds, the reaction mixture can be maintained at 86° C. for an additional 10 min. Ammonium persulfate solution (60 g, 0.9%) can then be added and, after a 75 min hold at 86° C., the reaction mixture can be cooled to ambient temperature and filtered. Distilled water can then be added to produce a HASE.

Preferably the associative thickener is present in the range of from 0.05 to 5 weight percent based on the weight of the composition.

Binders include acrylic emulsion copolymers, commercial examples of which include RHOPLEX™ VSR-2015 Acrylic Emulsion, RHOPLEX™ SG-10M Acrylic Emulsion, RHOPLEX™ VSR-1050 Acrylic Emulsion, RHOPLEX™ VSR-50 Acrylic Emulsion, RHOPLEX™ AC-261 Acrylic Emulsion, RHOPLEX™ SF-012 Acrylic Styrene Emulsion, PRIMAL™ SF-016 Acrylic Emulsion, PRIMAL™ AC-337N Acrylic Emulsion, ROVACE™ 9900 Vinyl Acetate Acrylic Emulsion, PRIMAL™ AS-380 Styrene Acrylic Emulsion, Acronal Optive 130 Acrylic Emulsion, Mowilith LDM 1852 EVA Emulsion, and combinations thereof. (RHOPLEX, ROVACE, and PRIMAL are all Trademarks of the Dow Chemical Company or its Affiliates). Preferably, the binder is present in the range of from 2 to 40 weight percent, more preferably in the range of from 5 to 30 weight percent, based on the weight of the composition.

Examples of opacifying pigments include zinc oxide, antimony oxide, zirconium oxide, chromium oxide, iron oxide, lead oxide, zinc sulfide, lithopone, and forms of titanium dioxide such as anatase and rutile. Preferably, the polymer-encapsulated opacifying pigment particles are rutile TiO₂ particles encapsulated in a copolymer, more preferably, rutile TiO₂ particles surface treated with oxides of aluminum and/or silicon. Examples of suitable encapsulating copolymers are polymers containing structural units of (meth)acrylate, styrene, or vinyl ester monomers; a combination of (meth)acrylate and styrene monomers, a combination of (meth)acrylate and vinyl ester monomers, and a combination of vinyl ester and ethylene monomers.

As used herein the term “structural units” refers the groups formed by the polymerization of the named monomer. A structural unit of methyl methacrylate is illustrated:

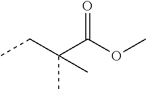

where the dotted lines represent the points of attachment to a polymer backbone.

The term the term “(meth)acrylate” refers to either acrylate or methacrylate; the term “(meth)acrylic” refers to acrylic or methacrylic; “(meth)acrylamide” refers to acrylamide or methacrylamide; and the term “(meth)acrylic” refers to acrylic or methacrylic.

(Meth)acrylate monomers especially suitable for the preparation of encapsulating copolymers include methyl (meth)acrylate, ethyl (meth)acrylate, and butyl (meth)acrylate and combinations thereof. For coatings applications, preferred (meth)acrylate monomers are combinations of butyl acrylate/methyl methacrylate; ethyl hexyl acrylate/methyl methacrylate; and butyl acrylate/ethyl hexyl acrylate/methyl methacrylate.

Vinyl acetate is a preferred vinyl ester monomer; for coatings applications, a combination of vinyl acetate and butyl acrylate or a combination of vinyl acetate, butyl acrylate, and a vinyl ester of a branched carboxylic acid monomer characterized by the following formula may be used:

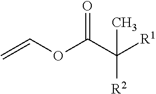

where R¹ and R² are each independently C₁-C₁₀-alkyl.

Examples of suitable vinyl esters of branched carboxylic acid monomers are the vinyl ester of neodecanoic acid (commercially available as VeoVa 10 monomer) and the vinyl ester of neononanoic acid acid (commercially available as VeoVa 9 monomer). When vinyl acetate or vinyl acetate and an acrylate monomer are used, it is preferred to include from 0.1 to 1 weight percent of acid functionalized monomers such as 2-acrylamido-2-methylpropane-sulfonic acid (AMPS) and sodium vinyl sulfonate.

(Meth)acrylate monomers such as butyl acrylate, ethyl acrylate, or 2-ethyl hexyl acrylate or combinations thereof may be used in combination with a styrene monomer such as styrene for making the encapsulating copolymer.

The monomers used to make the encapsulating polymers may also include a crosslinking monomer, which, at low levels, has been found to improve the hiding efficiency of the encapsulated particles. The crosslinking monomer is preferably a multiethylenically unsaturated crosslinking monomer, more preferably a diethylenically unsaturated monomer, used at a level sufficient to form a polymer that is resistant to deformation, preferably in the range of from 0.05 to 3 weight percent based on the weight of the encapsulating polymer. A preferred crosslinking monomer is allyl methacrylate (ALMA) used at a concentration of from 0.1 to 2 weight percent, based on the weight of the encapsulating polymer. The monomers may further include one or more acid functionalized monomers, preferably carboxylic acid functionalized monomers such as (meth)acrylic acid or itaconic acid in the range of from 0.5 to 3 weight percent, based on the weight of the encapsulating polymer.

The encapsulated opacifying pigments may be made by any appropriate techniques such as those described in the Examples, as well as in U.S. Pat. No. 7,579,081B1, EP1802662B1, and U.S. 2010/0298483. Preferably, the polymer-encapsulated opacifying pigment particles further include an amphoteric polymeric dispersant for the opacifying pigment particles and the encapsulating polymer.

The term “amphoteric polymeric dispersant” refers to a polymeric dispersant that contains amine functionality and acid functionality, preferably a polymer that is prepared from the copolymerization of an ethylenically unsaturated amine functional monomer and an ethylenically unsaturated sulfur-acid functional monomer. Examples of suitable ethylenically unsaturated amine functional monomers include dimethylamino ethyl(meth)acrylate, dimethylamino propyl(meth)acrylamide, and t-butylamino ethyl(meth)acrylate, with dimethylamino ethyl(meth)acrylate being preferred. Examples of suitable ethylenically unsaturated sulfur-acid functional monomers include sulfoethyl (meth)acrylate, sulfopropyl (meth)acrylate, styrene sulfonic acid, vinyl sulfonic acid, and 2-(meth)acrylamido-2-methyl propanesulfonic acid, and salts thereof, with 2-(meth)acrylamido-2-methyl propanesulfonic acid and sulfoethyl methacrylate being preferred.

In addition to containing amine and sulfur acid functionality, the amphoteric polymeric dispersant may additionally include functional groups arising from the compolymerization of water-soluble monomers such as hydroxyethyl(meth)acrylate, (meth)acrylamide, or (meth)acrylic acid, or combinations thereof.

Preferably, the polymer-encapsulated opacifying pigment particles are present in the range of 10 to 50 weight percent, more preferably from 20 to 45 weight percent, based on the weight of the composition. Preferably, water is present in the range of from 35 to 80, more preferably from 40 to 70 weight percent, based on the weight of the composition.

The composition of the present invention may further comprise additional components including solvents; fillers; extenders; dispersants, such as aminoalcohols and polycarboxylates; other pigments; other thickeners; surfactants; defoamers; preservatives, such as biocides, mildewcides, fungicides, algaecides, and combinations thereof; flow agents; leveling agents; coalescents; plasticizers; and neutralizing agents, such as hydroxides, amines, ammonia, and carbonates.

Associative thickeners generate viscosity by hydrophobic interactions with latex particles, which lead to latex-latex particle associations that tend to exclude pigment particles. Consequently, associatively thickened compositions have microscopic regions either rich in binder or rich in pigment, where the pigment rich microscopic regions have smaller TiO₂ particle spacing compared to non-associatively thickened compositions. The net result of TiO₂ pigment particle crowding is an overall reduction in scattering S/mil and opacity.

As the results in Table 1 show, encapsulating TiO₂ pigment particles with polymer produces S/mil values for HMHEC, HASE, and HEUR thickeners that are not substantially lower than what can be achieved for the HEC non-associative thickener; this increased opacity is likely due, in part, to the increased spacing of pigment particles provided by the presence of the encapsulating shell, which can interact with the hydrophobes of the associative thickener.

### EXAMPLES

The following examples are for illustrative purposes only and are not intended to limit the scope of the invention.

Intermediate 1—Preparation of Polymer Encapsulated TiO₂

To a 500-mL four-necked round bottom flask equipped with paddle stirrer, N₂-inlet, reflux condenser, heating mantel, and thermocouple was charged with TiO₂ slurry prepared substantially as described in U.S.20100298483A1, paragraphs 0053 and 0059 (194.9 g, 73.9% solids) with a solution of sodium dodecyl sulfate (SDS, 1.5 g) mixed in deionized (DI) water (10 g) and a separate solution of sodium styrene sulfonate (1.2 g in 10 g DI water). The flask was purged with N₂, and the temperature adjusted to 50° C., at which time aqueous solutions of 0.1% iron sulfate (4.0 g) and 1% ethylene diamines tetra-acetic acid sodium salt (0.4 g) were combined and added to the flask. Two minutes later co-feed #1 (1.6 g t-butyl hydroperoxide dissolved in 25 g DI water) and co-feed #2 (0.9 g isoascorbic acid dissolved in 25 g deionized water) were fed to the reactor at a rate of 0.25 g/min. Two minutes after the onset of the co-feed solution addition, a first monomer emulsion (ME 1) prepared by mixing DI water (6.0 g), SDS (0.75 g), butyl acrylate (BA,16.8 g), methyl methacrylate (MMA, 11.25 g), methacrylic acid (MAA, 0.30 g), and allyl methacrylate (ALMA, 0.14 g) was added at a rate of 2.0 g/min. After the completion of ME 1 addition, a second monomer emulsion (ME 2), prepared by mixing DI water (19.0 g), SDS (2.25 g), BA (50.45 g), MMA (34.2 g), and MAA (0.85 g) was fed to the reactor at a rate of 2.0 g/min at 50° C. When the ME 2 addition was complete, the co-feed #1 and #2 additions were continued for another 20 min until completion. The contents of the reactor were then cooled to room temperature and aqua ammonia (1 g, 28%) was added. The contents of the reactor were then filtered to remove any gel. The filtered dispersion had a solids content of 62.0% with 0.01 g (˜20 ppm) of dry gel removed.

Master paints 1-3 (MP1, MP2, and MP3) were prepared by combining the ingredients (in grams) listed in Table 1 with mixing in the order listed. SG-10M and VSR-2015 refer to RHOPLEX™ SG-10M Acrylic Emulsion and RHOPLEX™ VSR-2015 Acrylic Emulsion, respectively (RHOPLEX is a Trademark of The Dow Chemical Company or its Affiliates); TiPure R-746 refers to TiPure R-746 TiO₂.

TABLE 1
Preparation of Master Paints

| | MP1 | MP2 | MP3 |
|---|---|---|---|
| SG-10M | 261.95 | | |
| VSR-2015 | | 261.95 | 100.30 |
| Polymer Encapsulated TiO₂ | | | 279.54 |
| TiPure R-746 | 115.22 | 115.22 | |
| Water | 109.35 | 109.35 | 107.85 |
| Texanol | 10.48 | 10.48 | 10.48 |

Final paints made by adding thickeners to each of the master paints with mixing, as shown in Table 2. All measurements are in grams. Natrosol 250 MHR refers to Natrosol 250 MHR non-associative HEC thickener; Natrosol Plus 330 refers to Natrosol Plus 330 hydrophobically modified HEC thickener; RM-7 refers to ACRYSOL™ RM-7 HASE Thickening Agent; RM-2020NPR refers to ACRYSOL™ RM-2020NPR HEUR Thickening Agent; RM-8W refers to ACRYSOL™ RM-8W HEUR Thickening Agent (ACRYSOL is a Trademark of The Dow Chemical Company or its Affiliates).

TABLE 2
Preparation of Final Paints

| | Comp | Ex. 1 | Ex. 2 | Ex. 3 |
|---|---|---|---|---|
| Master Paint | 100 | 100 | 100 | 100 |
| Natrosol 250 MHR (3%) | 12 | | | |
| Natrosol Plus 330 (3%) | | 11.5 | | |
| RM-7 | | | 0.8 | |
| RM-2020NPR | | | | 1.0 |
| RM-8W | | | | 0.13 |

S/mil was determined for each of the final paint formulations as follows:

Kubelka-Munk S/mil Test Method

Two draw-downs were prepared on Black Release Charts (Leneta Form RC-BC) for each paint using a 1.5-mil Bird draw down bar and the charts allowed to dry overnight. Using a template, 3.25″×4″ rectangles were cut out with an X-ACTO knife on each chart. The y-reflectance was measured using a BYK Gardner 45° Reflectomer in each of the scribed areas five times measuring on a diagonal starting at the top of the rectangle and the average y-reflectance recorded. A thick film draw down was prepared for each paint on Black Vinyl Charts (Leneta Form P121-10N) using a 3″ 25 mil block draw down bar and the charts were allowed to dry overnight. The y-reflectance was measured in five different areas of the draw down and the average y-reflectance recorded. Kubelka-Munk hiding value S is given by Equation 1:

$$S = \frac{R}{X \times ( 1 - {R}^{2} )} \times ln \frac{1 - ( {R}_{B} \times R )}{1 - \frac{{R}_{B}}{R}} \qquad Equation 1$$

where X is the average film thickness, R is the average reflectance of the thick film and R_{B} is the average reflectance over black of the thin film. X can be calculated from the weight of the paint film (W_{pf}), the density (D) of the dry film; and the film area (A). Film area for a 3.25″×4″ template was 13 in².

$$X ( mils ) = \frac{{W}_{pf} ( g ) \times 1000 ( mil \text{/} in )}{D ( lbs \text{/} gal ) \times 1.964 ( g \text{/} {in}^{3} / lbs \text{/} gal ) \times A ( in )}$$

The S/mil of the paint formulations are given in Table 3. The standard deviation for each measurement was 0.1. The numbers in parenthesis indicate the percent difference in S/mil between the example thickeners and the associative HEC thickener (Comparative).

TABLE 3
S/mil of Formulations

| | Comp | Ex. 1 | | Ex. 3 |
|---|---|---|---|---|
| | Natrosol | Natrosol | Ex. 2 | RM-2020NPR + |
| | 250 MHR | Plus 330 | RM-7 | RM-8W |
| SG-10M | 6.65 | 4.21 (37%) | 5.86 (12%) | 2.96 (55%) |
| VSR-2015 | 6.77 | 5.28 (21%) | 6.27 (7%) | 3.56 (47%) |
| Encapsulated | 8.11 | 7.91 (2%) | 7.91 (2%) | 7.67 (5%) |
| TiO₂ | | | | |

The results show that the non-associative HEC thickener exhibits the highest S/mil for both encapsulated and unencapsulated TiO₂; however, the reduction of S/mil normally observed for associative thickeners is mitigated by the encapsulated TiO₂ to the extent that the associative HMHEC and HASE thickeners (Examples 1 and 2 respectively) are only about 2% lower than the non-associative HEC thickener; more surprisingly, the associative HEUR thickener (Example 3) is only about 5% lower. In contrast, where unencapsulated TiO₂ is used, as much as a 55% reduction in S/mil is observed for the purely associative thickener versus the purely non-associative thickener.

1. A composition comprising:
a) 0.02-10 weight percent of an associative thickener;
b) 1-50 weight percent of a binder;
c) 1-60 weight percent of polymer-encapsulated opacifying pigment particles; and
d) 35-90 weight percent water;
wherein the weight percentages are based on the total weight of the composition; and
wherein the opacifying pigment particles have a number average diameter in the range of 100 nm to 500 nm and an index of refraction of at least 1.8; and are encapsulated or partially encapsulated in an encapsulating polymer.

2. The composition of claim 1 wherein the associative thickener includes a HEUR thickener.

3. The composition of claim 1 wherein the associative thickener includes a HASE thickener.

4. The composition of claim 1 wherein the associative thickener includes an HMHEC thickener.

5. The composition of any of claim 1 wherein the opacifying pigment particles are TiO₂ particles; the encapsulating polymer contains structural units of: (meth)acrylate, styrene, or vinyl ester monomers, or a combination of (meth)acrylate and styrene monomers, or a combination of (meth)acrylate and vinyl ester monomers, or a combination of vinyl ester and ethylene monomers; which polymer-encapsulated opacifying pigment particles further include an amphoteric polymeric dispersant for the opacifying pigment particles and the encapsulating polymer.

6. The composition of claim 5 wherein the encapsulating polymer further includes structural units of a crosslinking monomer and an acid functionalized monomer.

7. A composition comprising:
a) 0.05-5 weight percent of a HEUR thickener;
b) 1-30 weight percent of a binder;
c) 20-45 weight percent of polymer-encapsulated TiO₂ particles; and
d) 40-70 weight percent water;
wherein the weight percentages are based on the total weight of the composition; and
wherein the TiO₂ have a number average diameter in the range of 100 nm to 500 nm; and are encapsulated an encapsulating polymer, which polymer-encapsulated TiO₂ particles further include an amphoteric polymeric dispersant for the TiO₂ particles particles and the encapsulating polymer, wherein the amphoteric polymeric dispersant contains amine functionality and sulfur acid functionality.
